(19) United States
(12) Patent Application Publication
(10) Pub. No.: US 2014/0009021 A1
(43) Pub. Date: Jan. 9, 2014

(54) SPINDLE MOTOR

(71) Applicant: Samsung Electro-Mechanics Co., Ltd, Suwon (KR)

(72) Inventors: Shin Young CHEONG, Suwon (KR); Jung Hwan SONG, Suwon (KR); Heung Suk GO, Suwon (KR)

(21) Appl. No.: 13/917,244

(22) Filed: Jun. 13, 2013

(30) Foreign Application Priority Data
Jul. 5, 2012 (KR) 10-2012-0073467

(51) Int. Cl. H02K 5/16

(52) U.S. Cl. CPC H02K 5/165
USPC 310/90

(57) ABSTRACT

There is provided a spindle motor including: a base member; a shaft fixed to the base member and including a lower thrust member disposed on a lower end portion thereof and an upper flange member disposed on an upper end portion thereof; and a rotating part forming, together with the upper flange member, the lower thrust member, and the shaft, bearing clearances filled with a lubricating fluid, and rotated around the shaft, wherein the lower thrust member includes amounting part on which a stator core is mounted, and at least one of a surface of the lower thrust member disposed to face a surface of the rotating part and the surface of the rotating part includes a lower thrust dynamic pressure generating groove formed therein.

### CROSS-REFERENCE TO RELATED APPLICATIONS

This application claims the priority of Korean Patent Application No. 10-2012-0073467 filed on Jul. 5, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device provided in a computer, reads data stored on a disk or writes data to a disk using a magnetic read-write head.

In such a hard disk drive, a base plate has a head driver capable of moving the magnetic head relative to the disk installed thereon. The magnetic head performs its function while moving to a desired position relative to the disk in a state in which it is suspended above a writing surface of the disk at a predetermined height by the head driver.

According to the related art, in manufacturing a base plate provided in the hard disk drive, a post-processing scheme of die-casting aluminum (Al) and then removing burrs, or the like, generated due to the die-casting, has been used.

However, in the die-casting scheme according to the related art, since a process of injecting aluminum (Al) in a molten state to be forged is performed, high levels of temperature and pressure are required, and thus, a large amount of energy is required in the process and a process time may be increased.

Further, in terms of a lifespan of a die-casting mold, there is a limitation in manufacturing a large number of base plates using a single mold, and a base plate manufactured by the die-casting process may have poor dimensional precision.

Therefore, the base member has been manufactured by a pressing or forging method in order to solve these problems of the die-casting method. However, in this case, a stator core installing member for installing a stator core should be separately installed on a base member.

That is, since the stator core may not be directly installed on the base member manufactured by the pressing or forging method and formed to have a uniform thickness, a stator core installing member should be installed on the base member.

In addition, since the stator core installing member is generally manufactured by die-casting or injection molding, a phenomenon in which the center of the stator core is off-set from a central axis of the shaft due to assembly tolerance or processing tolerance of the stator core installing member and the base member occurs.

That is, an increase in assembly tolerance due to assembly of the stator core installing member, the base member, and a sleeve is caused. Therefore, a phenomenon in which the center of the stator core is off-set from the central axis of the shaft occurs.

### RELATED ART DOCUMENT

(Patent Document 1) Korean Patent Laid-Open Publication No. 2004-75303

### SUMMARY OF THE INVENTION

An aspect of the present invention provides a spindle motor capable of decreasing processing tolerance and assembly tolerance generated at the time of processing and assembling.

Another aspect of the present invention also provides a spindle motor in which a stator core may be more stably installed.

According to an embodiment of the present invention, there is provided a spindle motor including: a shaft fixed to the base member and including a lower thrust member disposed on a lower end portion thereof and an upper flange member disposed on an upper end portion thereof; and a rotating part forming, together with the upper flange member, the lower thrust member, and the shaft, bearing clearances filled with a lubricating fluid, and rotated around the shaft, wherein the lower thrust member includes a mounting part on which a stator core is mounted, and at least one of a surface of the lower thrust member disposed to face a surface of the rotating part and the surface of the rotating part includes a lower thrust dynamic pressure generating groove formed therein.

The lower thrust member may include: a disk part having a disk shape, a sealing part bent from the disk part in an axial direction and forming, together with the rotating part, a first liquid-vapor interface, and a mounting part extended from the sealing part and having the stator core mounted on an outer surface thereof.

The mounting part may include an extension wall body having an outer surface bonded to an inner peripheral surface of the stator core and a installation guiding wall bent from the extension wall body and bonded to an upper surface of the stator core.

The base member may include a coupling part for increasing an area of contact thereof with the lower thrust member, and a spacing distance between a lower surface of an inner diameter portion of the stator core and an upper surface of the coupling part is greater than a spacing distance between an upper surface of the inner diameter portion of the stator core and a lower surface of the installation guiding wall when the stator core is mounted on the mounting part.

The mounting part may include a first wall body extended from the sealing part in a radial direction, a second wall body extended from the first wall body downwardly and upwardly in the axial direction, and a installation guiding wall extended from an upper end portion of the second wall body in the radial direction.

The lower thrust member may be configured of two members separated in a region in which the first wall body is disposed or formed integrally with each other.

The base member may include a coupling part for increasing an area of contact thereof with the lower thrust member, and a lower surface of the first wall body is provided with a recessed groove into which the coupling part is inserted.

The mounting part may include a support wall body supported by an upper surface of the base member and having a seating surface on which the stator core is seated, and a bonding wall body to which an inner peripheral surface of the stator core is bonded.

A surface of the base member disposed to face a lower surface of the support wall body may be flat.

The mounting part may include a horizontally extended wall body extended from an upper end portion of the sealing part in a radial direction, a seating wall body extended from a lower end portion of the horizontally extended wall body, and a vertically extended wall body extended from an upper end portion of the horizontally extended wall body upwardly in the axial direction and having an inner peripheral surface of the stator core bonded thereto.

The base member may include a coupling part inserted into a mounting groove formed in a lower surface of the horizontally extended wall body.

The upper flange member may include a body having a disk shape and a protrusion part extended from the body downwardly in an axial direction and inserted into an insertion groove of the rotating part, and the thrust member maybe inclined in order to form, together with an outer sidewall forming the insertion groove, a second liquid-vapor interface.

The spindle motor may further include a cover member installed on any one of an upper end portion of the upper flange member and the rotating part to prevent leakage of the lubricating fluid.

The rotating part may include a sleeve forming, together with the upper flange member, the lower thrust member, and the shaft, the bearing clearances, and a rotor hub extended from the sleeve.

The mounting part and a surface of the rotating part disposed to face the mounting part may form a labyrinth seal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a cut-away perspective view showing a lower thrust member included in the spindle motor according to the embodiment of the present invention;

FIG. 4 is a schematic cross-sectional view showing a spindle motor according to another embodiment of the present invention;

FIG. 5 is an enlarged view showing part B of FIG. 4;

FIG. 6 is a cross-sectional view schematically showing a spindle motor according to another embodiment of the present invention; and

FIG. 7 is a cross-sectional view schematically showing a spindle motor according to another embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same or like reference numerals will be used throughout to designate the same or like components.

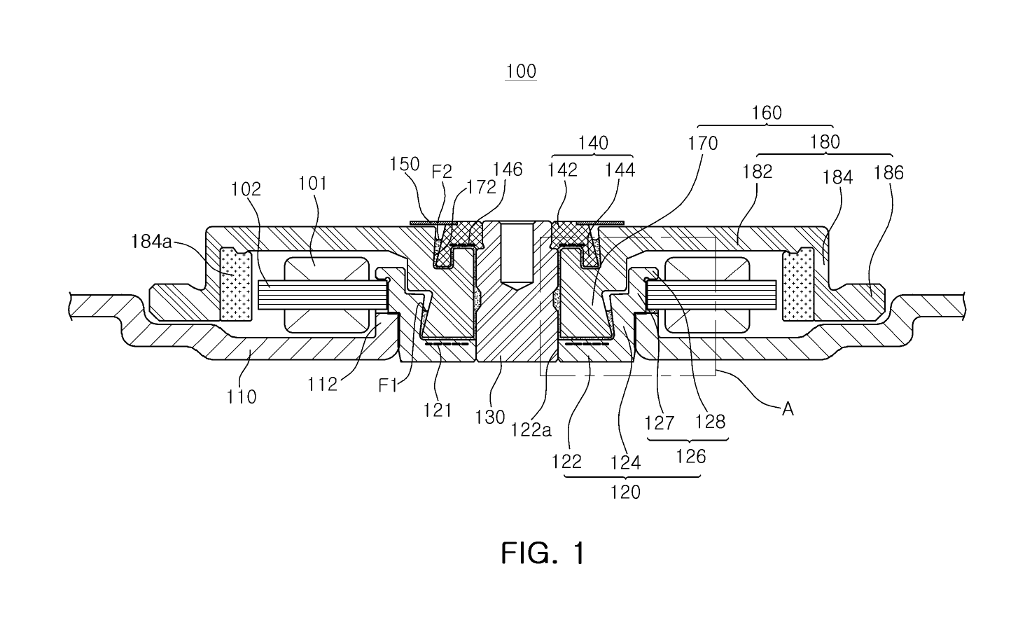

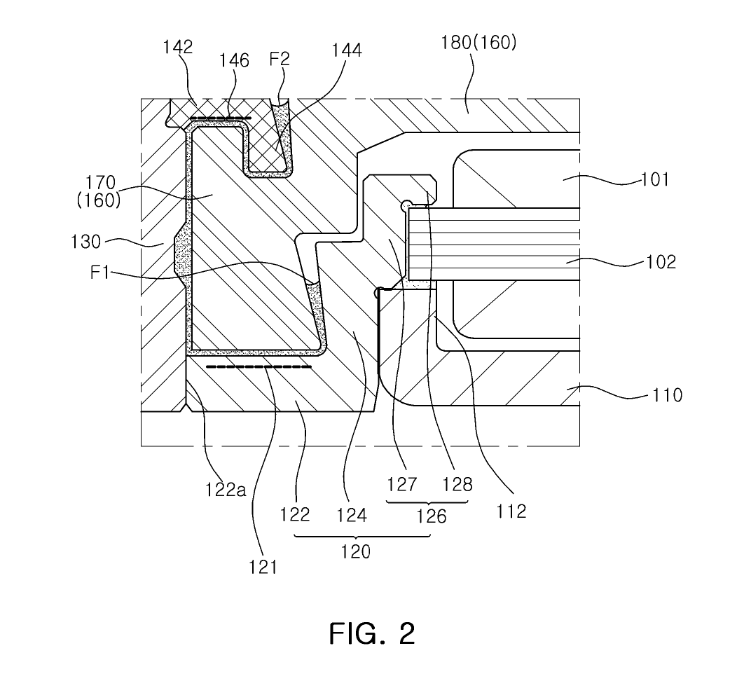

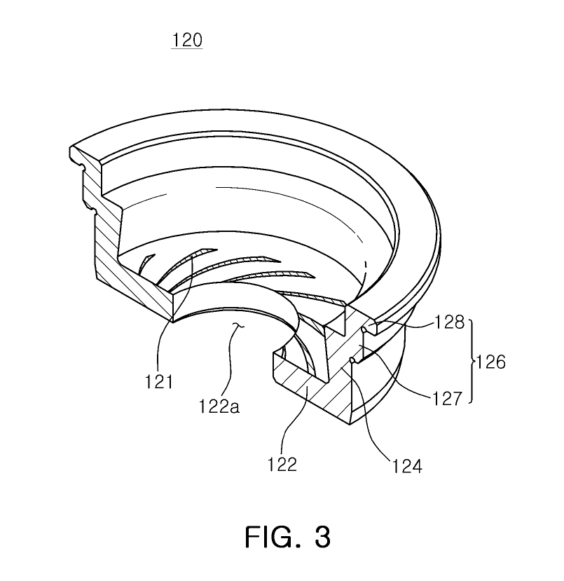

FIG. 1 is a schematic cross-sectional view showing a spindle motor according to an embodiment of the present invention; FIG. 2 is an enlarged view of part A of FIG. 1; and FIG. 3 is a cut-away perspective view showing a lower thrust member included in the spindle motor according to the embodiment of the present invention.

Referring to FIGS. 1 through 3, a spindle motor 100 according to the embodiment of the invention may include abase member 110, a lower thrust member 120, a shaft 130, an upper flange member 140, a cover member 150, and a rotating part 160 by way of example.

Here, terms with respect to directions will be defined. As viewed in FIG. 1, an axial direction refers to a vertical direction, that is, a direction from a lower end portion of the shaft 130 toward an upper end portion thereof or a direction from the upper end portion of the shaft 130 toward the lower end portion thereof, and a radial direction refers to a horizontal direction, that is, a direction from an outer peripheral surface of the rotating part 160 toward the shaft 130 or from the shaft 130 toward the outer peripheral surface of the rotating part 160.

In addition, a circumferential direction refers to a rotation direction along the shaft 130 or the outer peripheral direction of the rotating part 160.

The base member 110 may include a coupling part 112 extended upwardly in the axial direction.

The coupling part 112 may serve to increase an area of contact thereof with the lower thrust member 120 to increase coupling force between the lower thrust member 120 and the base member 110. In addition, the coupling part 112 may serve to allow a stator core 102 to be more stably installed.

In addition, the base member 110 may be manufactured by die-casting aluminum (Al). Alternatively, the base member 110 may be molded by performing plastic working (for example, press working) on a steel plate.

That is, the base member 110 may be manufactured by various materials and various processing methods, and is not limited to a shape of the base member 110 shown in the accompanying drawings.

The lower thrust member 120 may be fixedly installed on the base member 110. Meanwhile, the lower thrust member 120 may include a disk part 122 having a disk shape, a sealing part 124 bent from the disk part 122 in the axial direction and forming, together with the rotating part 160, a first liquid-vapor interface F1, and a mounting part 126 extended from the sealing part 124 and having the stator core 102 mounted on an outer surface thereof.

The mounting part 126 may include an extension wall body 127 having an outer surface bonded to an inner peripheral surface of the stator core 102 and a installation guiding wall 128 bent from the extension wall body 127 and bonded to an upper surface of the stator core 102.

Here, a method of installing the stator core 102 will be described.

The stator core 102 may first be installed on the mounting part 126 of the lower thrust member 120. In this case, the stator core 102 may be installed on the mounting part 126 of the lower thrust member 120 through an adhesive.

Meanwhile, an upper surface of an inner diameter portion of the stator core 102 may be bonded to a lower surface of the installation guiding wall 128 so as to be closely adhered thereto, and the inner peripheral surface of the stator core 102 may be bonded to an outer peripheral surface of the extension wall body 127 so as to be closely adhered thereto.

In addition, a groove accommodating an adhesive provided therein may be formed at an edge formed by the lower surface of the installation guiding wall 128 and the outer peripheral surface of the extension wall body 127. Therefore, contamination due to the adhesive may be decreased, and coupling force between the stator core 102 and the lower thrust member 120 may be further increased by the adhesive accommodated in the groove.

Then, finally, the base ember 110 and the lower thrust member 120 may be coupled to each other. In this case, an outer peripheral surface of the sealing part 124 of the lower thrust member 120 may be bonded to an inner peripheral surface of the coupling part 112 of the base member 110.

In addition, an inner side of an upper surface of the coupling part 112 may be bonded to a lower surface of the extension wall body 127 of the lower thrust member 120.

Further, the lower thrust member 120 and the coupling part 112 of the base member 110 may be bonded to each other by at least one of an adhesion method, a press-fitting method, and a welding method.

Meanwhile, an outer side of the upper surface of the coupling part 112 may be disposed to be spaced apart from a lower surface of the inner diameter portion of the stator core 102, and a space formed by the outer side of the upper surface of the coupling part 112 and the lower surface of the inner diameter portion of the stator core 102 may be filled with an adhesive.

That is, the upper surface of the coupling part 112 and the lower surface of the stator core 102 may be bonded to each other by the adhesive.

In addition, a spacing distance between the lower surface of the inner diameter portion of the stator core 102 and the upper surface of the coupling part 112 may be greater than a spacing distance between the upper surface of the inner diameter portion of the stator core 102 and the lower surface of the installation guiding wall 127.

Therefore, a larger amount of adhesive for bonding to the stator core 102 may be applied to the lower surface of the inner diameter portion of the stator core 102 than to the upper surface thereof.

As described above, since the inner peripheral surface, the upper surface of the inner diameter portion, and the lower surface of the inner diameter portion of the stator core 102 are bonded to the lower thrust member 120 and the base member 110, an area of contact therebetween may be increased to implement an increase in coupling force.

In addition, since an assembling reference surface of the stator core 102 is formed on the lower thrust member 120, a phenomenon in which the center of the stator core 102 is off-set from that of the shaft 130 due to processing tolerance and assembly tolerance may be decreased.

In other words, the off-set phenomenon due to processing tolerance and assembly tolerance may be decreased as compared with the case in which the assembling reference surface is formed on the base member 110 or a separate installation member of the stator core 102.

Further, an edge of a lower end portion of the extension wall body 127 may be rounded so that the stator core 102 may be more easily assembled at the time of being assembled. In addition, a chamfer may be formed at the lower end portion of the extension wall body 127 so that the stator core 102 may be more easily assembled.

Meanwhile, the lower thrust member 120 may have a lower thrust dynamic pressure generating groove 121 formed in one surface thereof disposed to face the rotating part 160.

That is, the lower thrust dynamic pressure generating groove 121 may be formed in the lower thrust member 120 in order to generate thrust fluid dynamic pressure at the time of rotation of the rotating part 160 to more stably rotate the rotating part 160.

In addition, the lower thrust dynamic pressure generating groove 121 may be formed on an upper surface of the disk part 122. However, the lower thrust dynamic pressure generating groove 121 is not limited to being formed on the upper surface of the disk part 122, but may also be formed in a surface of the rotating part 160 disposed to face the upper surface of the disk part 122.

The shaft 130 may have the lower end portion fixedly installed on the lower thrust member 120.

That is, the lower end portion of the shaft 130 may be inserted into a mounting hole 122a formed in the disk part 122 of the lower thrust member 120. In addition, the lower end portion of the shaft 130 may be bonded to an inner surface of the disk part 122 of the lower thrust member 120 by at least one of an adhesion method, a press-fitting method, and a welding method.

Therefore, the lower end portion of the shaft 130 may be fixed to the lower thrust member 120.

Meanwhile, the shaft 130 may serve to form, together with the rotating part 160, a bearing clearance. A detailed description of the bearing clearance will be provided below.

The upper flange member 140 may be fixedly installed on the upper end portion of the shaft 130. In addition, the upper flange member 140 may include a body having a disk shape and a protrusion part 144 extended from the body 142 downwardly in the axial direction and inserted into an insertion groove 172 of the rotating part 160.

Meanwhile, the upper flange member 140 may be inclined in order to form, together with an outer sidewall forming the insertion groove 172, a second liquid-vapor interface F2.

In addition, an upper surface of the upper flange member 140 may be stepped so that the cover member 150 may be installed thereon.

In addition, the body 142 of the upper flange member 140 may have an upper thrust dynamic pressure generating groove 146 formed in a lower surface thereof in order to generate thrust dynamic pressure so that the rotating part 160 may be more stably rotated.

However, the upper thrust dynamic pressure generating groove 146 may also be formed in a surface of the rotating part 160 disposed to face the lower surface of the body 142.

In the present embodiment, the lower thrust member 120 and the upper flange member 140 are installed on the lower end portion and the upper end portion of the shaft 130 by way of example; however, at least one of the lower thrust member 120 and the upper flange member 140 may be formed integrally with the shaft 130.

The cover member 150 may be installed on any one of an upper end portion of the upper flange member 140 and the rotating part 160 to serve to prevent leakage of the lubricating fluid. As an example, the cover member 150 may be installed on a stepped portion in the upper surface of the flange member 140 to suppress the leakage of the lubricating fluid.

Meanwhile, in the case in which the cover member 150 is installed on the upper flange member 140, a lower surface of the cover member 150 and a surface of the rotating part 160 facing the cover member 150 may be disposed to be spaced apart from each other by a predetermined distance to form a labyrinth seal.

As described above, the cover member 150 may serve to suppress evaporation of the lubricating fluid.

Although the case in which the cover member 150 is installed on the upper flange member 140 has been described by way of example in the present embodiment, the invention is not limited thereto. That is, the cover member 150 may also be installed on the rotating part 160. In this case, the lower surface of the cover member 150 and the upper surface of the upper flange part 140 may be disposed to be spaced apart from each other by a predetermined distance to form a labyrinth seal.

The rotating part 160 may form, together with the upper flange member 140, the lower thrust member 120, and the shaft 130, bearing clearances filled with the lubricating fluid, and be rotated around the shaft 130.

In addition, the rotating part 160 may include a sleeve 170 forming, together with the upper flange member 140, the lower thrust member 120, and the shaft 130, the bearing clearances, and a rotor hub 180 extended from the sleeve 170.

In addition, the sleeve 170 and the rotor hub 180 may be formed integrally with each other as shown in the accompanying drawings. However, the sleeve 170 and the rotor hub 180 are not limited to being formed integrally with each other, and may also be separately manufactured and then coupled to each other.

Meanwhile, a lower end portion of an outer peripheral surface of the sleeve 170 may be inclined so as to form, together with the sealing part 124 of the lower thrust member 120, the first liquid-vapor interface F1.

In addition, an upper end portion of the sleeve 170 may be provided with the insertion groove 172 into which the protrusion part 144 of the upper flange member 140 is inserted. In addition, as described above, an outer peripheral surface of the upper flange member 140 and the outer sidewall of the insertion groove 172 may serve to allow the second liquid-vapor interface F2 to be formed.

Next, the bearing clearance will be described in more detail.

As described above, the first liquid-vapor interface F1 may be disposed in a space formed by the lower end portion of the outer peripheral surface of the sleeve 170 and the sealing part 124 and be formed upwardly in the axial direction. In addition, the second liquid-vapor interface F2 may be disposed in a space formed by the outer peripheral surface of the upper flange member 140 and the outer sidewall of the insertion groove 172 and be formed upwardly in the axial direction, similar to the first liquid-vapor interface F1.

Meanwhile, an inner peripheral surface of the sleeve 170 may be disposed to be spaced apart from the outer peripheral surface of the shaft 130 by a predetermined distance to form a bearing clearance. In addition, the sleeve 170 and the upper flange member 140 may be disposed to be spaced apart from each other by a predetermined distance to form a bearing clearance, and the sleeve 170 and the lower thrust member 120 may be disposed to be spaced apart from each other by a predetermined distance to form a bearing clearance.

In addition, the above-mentioned bearing clearances may be connected to each other and filled with the lubricating fluid. That is, the spindle motor 100 according to the embodiment of the invention may have a full-fill structure in which all of the above-mentioned bearing clearances are filled with the lubricating fluid.

In addition, the sleeve 170 and the lower thrust member 120 may form a labyrinth seal so as to suppress evaporation of the lubricating fluid. That is, a portion of the sleeve 170 disposed to face an inner surface of the mounting part 126 of the lower thrust member 120 may have a shape corresponding to that of the mounting part 126 to form the labyrinth seal.

Meanwhile, the sleeve 170 may include upper and lower radial dynamic pressure grooves (not shown) formed in the inner peripheral surface thereof in order to generate fluid dynamic pressure in the radial direction at the time of rotation of the rotating part 160.

The rotor hub 180 may be extended from the upper end portion of the sleeve 170 in the radial direction. In addition, the rotor hub 180 may include a rotor hub body 182 having a disk shape, a magnet mounting part 184 extended from an edge of the rotor hub body 182 and having a driving magnet 184a mounted on an inner surface thereof, and a disk seating part 186 extended from a distal end of the magnet mounting part 184 in an outer radial direction.

Meanwhile, the driving magnet 184a may have an annular ring shape and be a permanent magnet generating a magnetic field having predetermined strength by alternately magnetizing an N pole and an S pole in the circumferential direction.

In addition, the driving magnet 184a may be disposed to face a front end of the stator core 102 having a coil 101 wound therearound and serve to generate driving force capable of rotating the rotating part 160 by electromagnetic interaction with the stator core 102 having the coil 101 wound therearound.

That is, when power is supplied to the coil 101, driving force capable of rotating the rotating member 160 is generated by the electromagnetic interaction between the stator core 102 having the coil 101 wound therearound and the driving magnet 184a disposed to face the stator core 102, such that the rotating member 160 may be rotated around the shaft 130.

As described above, since the stator core 102 is mounted on the mounting part 126 of the lower thrust member 120, processing tolerance and assembly tolerance may be decreased. In other words, processing tolerance and assembly tolerance may be decreased as compared with the case in which the lower thrust member 120 is installed on the base member 110 or is installed on a separate installation member assembled to the base member 110.

Therefore, a phenomenon in which the center of the stator core 102 is off-set from that of the shaft 130 due to processing tolerance and assembly tolerance may be decreased.

In addition, since the upper surface of the stator core 102 is bonded to the installation guiding wall 127 and the lower surface of the stator core 102 is bonded to the upper surface of the coupling part 112 of the base member 110 through the adhesive, a bonding area between the stator core 102 and the mounting part 126 may be increased. Therefore, the coupling force between the stator core 102 and the mounting part 126 may be increased. As a result, the stator core 102 may be more stably installed.

In addition, the labyrinth seal may be formed by the inner surface of the mounting part 126 of the lower thrust member 120 and the sleeve 170, and a length of the labyrinth seal sufficient to suppress the evaporation of the lubricating fluid may be secured.

Hereinafter, a spindle motor according to another embodiment of the invention will be described with reference to the accompanying drawings. However, components that are the same as the above-mentioned components will be denoted by the same reference numerals and a detailed description thereof will be omitted.

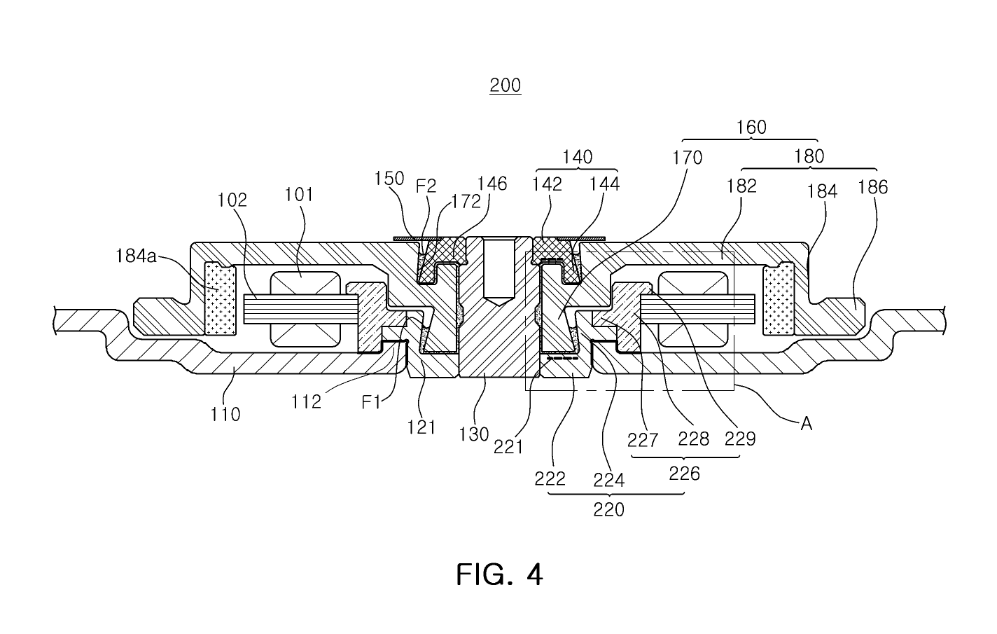

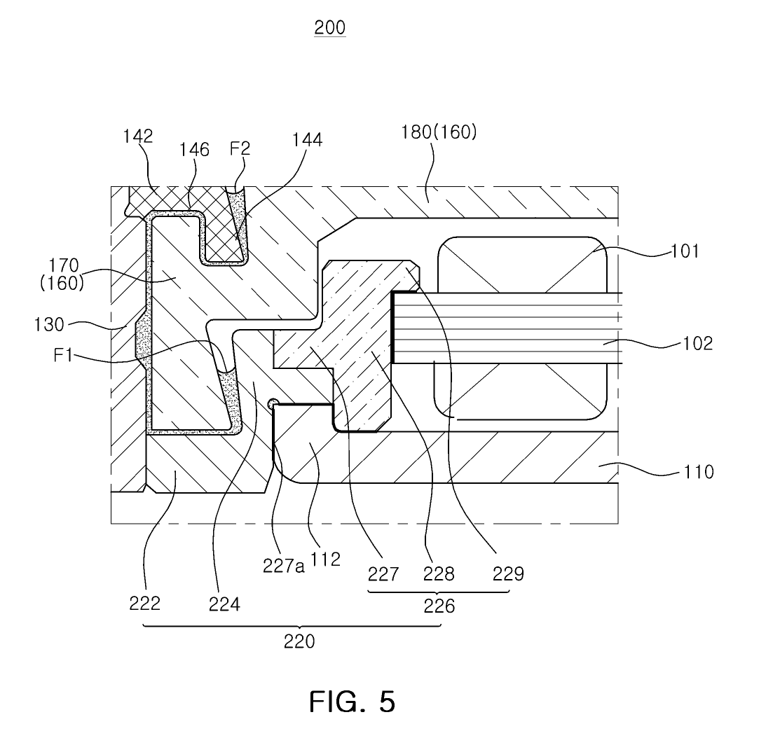

FIG. 4 is a schematic cross-sectional view showing a spindle motor according to another embodiment of the present invention; and FIG. 5 is an enlarged view showing part B of FIG. 4.

Meanwhile, a spindle motor 200 according to another embodiment of the invention is different from the spindle motor 100 according to the above-described embodiment of the invention only in terms of a lower thrust member 220. Hereinafter, only the lower thrust member 220 will be described, and a detailed description of the other components will be omitted.

Referring to FIGS. 4 and 5, the lower thrust member 220 may be fixedly installed on the base member 110. Meanwhile, the lower thrust member 220 may include a disk part 222 having a disk shape, a sealing part 224 bent from the disk part 222 in the axial direction and forming, together with the rotating part 160, a first liquid-vapor interface F1, and a mounting part 226 extended from the sealing part 224 and having the stator core 102 mounted on an outer surface thereof.

The mounting part 226 may include a first wall body 227 extended from the sealing part 224 in the radial direction, a second wall body 228 extended from the first wall body 227 downwardly and upwardly in the axial direction, and a installation guiding wall 229 extended from an upper end portion of the second wall body 228 in the radial direction.

Meanwhile, the base member 110 may include the coupling part 112 in order to increase an area of contact thereof with the lower thrust member 220, and a lower surface of the first wall body 227 may be provided with a recessed groove 227a into which the coupling part 112 is inserted.

In addition, a lower surface of the second wall body 228 may be supported by an upper surface of the base member 110.

In addition, an edge of a lower end portion of the second wall body 228 may be rounded so that the stator core 102 may be more easily assembled. In addition, the second wall body 228 may also have a chamfer formed on the lower end portion thereof so that the stator core 102 may be more easily assembled.

As described above, since the coupling part 112 of the base member 110 may be inserted into the recessed groove 227a of the lower thrust member 220 and the lower surface of the second wall body 228 may be supported by the upper surface of the base member 110, coupling force between the lower thrust member 220 and the base member 110 may be increased.

In addition, since the stator core 102 is bonded to the mounting part 226 based on a lower surface of the installation guiding wall 229, a phenomenon in which the center of the stator core 102 is off-set from that of the shaft 130 due to processing tolerance and assembly tolerance may be decreased.

In other words, the off-set phenomenon due to processing tolerance and assembly tolerance may be decreased as compared with the case in which the assembling reference surface is formed on the base member 110 or a separate installation member of the stator core 102.

Meanwhile, the lower thrust member 220 may be configured of two members separated in a region in which the first wall body 227 is disposed or formed integrally with each other.

In addition, the lower thrust member 220 may have a lower thrust dynamic pressure generating groove 221 formed in one surface thereof disposed to face the rotating part 160.

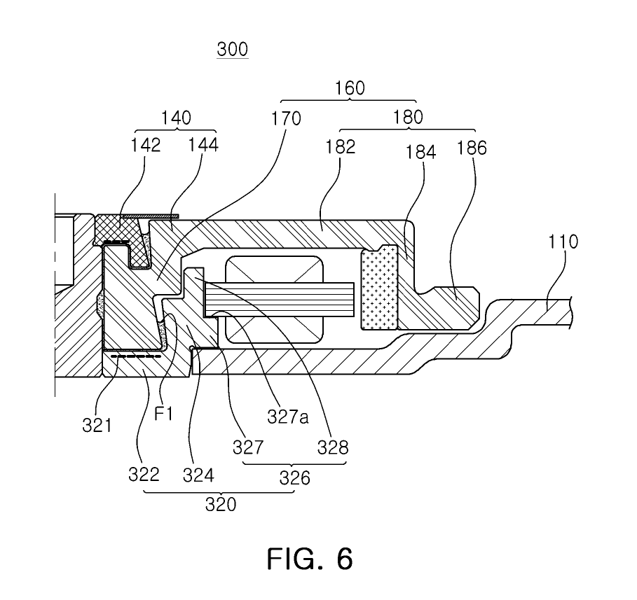

FIG. 6 is a cross-sectional view schematically showing a spindle motor according to another embodiment of the present invention.

Meanwhile, a spindle motor 300 according to another embodiment of the invention is different from the spindle motor 100 according to the above-described embodiment of the invention only in terms of a lower thrust member 320. Hereinafter, only the lower thrust member 320 will be described, and a detailed description of the other components will be omitted.

Referring to FIG. 6, the lower thrust member 320 may be fixedly installed on the base member 110. Meanwhile, the lower thrust member 320 may include a disk part 322 having a disk shape, a sealing part 324 bent from the disk part 222 in the axial direction and forming, together with the rotating part 160, a first liquid-vapor interface F1, and a mounting part 326 extended from the sealing part 324 and having the stator core 102 mounted on an outer surface thereof.

The mounting part 326 may include a support wall body 327 supported by the upper surface of the base member 100 and having a seating surface 327a on which the stator core 102 is seated and a bonding wall body 228 to which the inner peripheral surface of the stator core 102 is bonded.

In addition, a surface of the base member 110 disposed to face a lower surface of the support wall body 327 may be flat. That is, the coupling part 112 of the base member 110 shown in FIG. 1 may not be formed in the present embodiment.

In addition, the lower thrust member 320 may have a lower thrust dynamic pressure generating groove 321 formed in one surface thereof disposed to face the rotating part 160.

As described above, since the stator core 102 is bonded to the mounting part 326 based on the seating surface 327a of the support wall body 327, a phenomenon in which the center of the stator core 102 is off-set from that of the shaft 130 due to processing tolerance and assembly tolerance may be decreased.

In other words, the off-set phenomenon due to processing tolerance and assembly tolerance may be decreased as compared with the case in which the assembling reference surface is formed on the base member 110 or a separate installation member of the stator core 102.

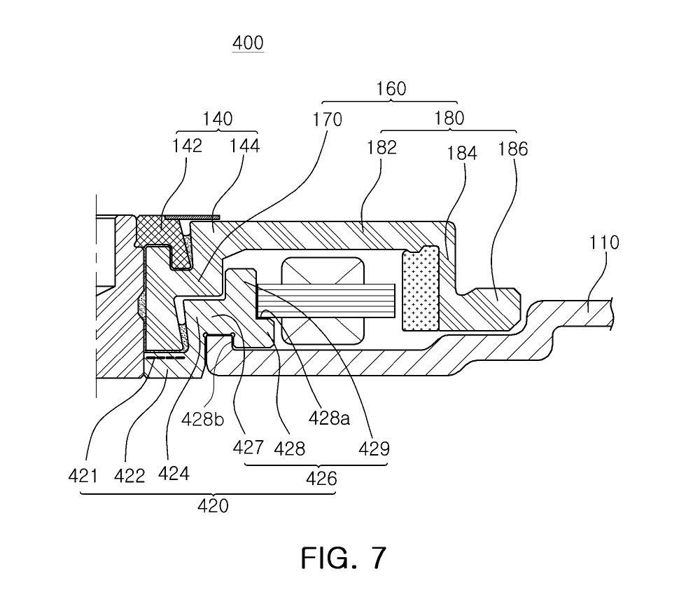

FIG. 7 is a cross-sectional view schematically showing a spindle motor according to another embodiment of the present invention.

Meanwhile, a spindle motor 400 according to another embodiment of the invention is different from the spindle motor 100 according to the above-described embodiment of the invention only in terms of a lower thrust member 420. Hereinafter, only the lower thrust member 420 will be described, and a detailed description of the other components will be omitted.

Referring to FIG. 7, the lower thrust member 420 may be fixedly installed on the base member 110. Meanwhile, the lower thrust member 420 may include a disk part 422 having a disk shape, a sealing part 424 bent from the disk part 422 in the axial direction and forming, together with the rotating part 160, a first liquid-vapor interface F1, and a mounting part 426 extended from the sealing part 424 and having the stator core 102 mounted on an outer surface thereof.

The mounting part 426 may include a horizontally extended wall body 427 extended from an upper end portion of the sealing part 424 in the radial direction, a seating wall body 428 extended from a lower end portion of the horizontally extended wall body 427, and a vertically extended wall body 429 extended from an upper end portion of the horizontally extended wall body 427 upwardly in the axial direction and having an inner peripheral surface of the stator core 102 bonded thereto.

Meanwhile, the stator core 102 may be bonded to the lower thrust member 420 in a state in which it is seated on a seating surface 428a of the seating wall body 428. In this case, the inner peripheral surface of the stator core 102 may be bonded to an outer surface of the vertically extended wall body 429.

In addition, the base member 110 may include a coupling part 112 inserted into a mounting groove 428b formed in a lower surface of the horizontally extended wall body 428.

In addition, the lower thrust member 420 may have a lower thrust dynamic pressure generating groove 421 formed in one surface thereof disposed to face the rotating part 160.

As described above, since the stator core 102 is bonded to the mounting part 426 based on the seating surface 428a of the seating wall body 428, a phenomenon in which the center of the stator core 102 is off-set from that of the shaft 130 due to processing tolerance and assembly tolerance may be decreased.

In other words, the off-set phenomenon due to the processing tolerance and the assembly tolerance may be decreased as compared with the case in which the assembling reference surface is formed on the base member 110 or a separate installation member of the stator core 102.

As set forth above, according to the embodiments of the invention, the stator core is mounted on the mounting part of the lower thrust member, whereby processing tolerance and assembly tolerance may be decreased.

In addition, the upper surface of the stator core is bonded to the installation guiding wall and the lower surface of the stator core is bonded to the upper surface of the coupling part of the base member through the adhesive, whereby the stator core may be more stably installed.

That is, the stator core is provided to be bonded to the base member and the lower thrust member, whereby the stator core may be more stably installed.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member;
a shaft fixed to the base member and including a lower thrust member disposed on a lower end portion thereof and an upper flange member disposed on an upper end portion thereof; and
a rotating part forming, together with the upper flange member, the lower thrust member, and the shaft, bearing clearances filled with a lubricating fluid, and rotated around the shaft,
wherein the lower thrust member includes a mounting part on which a stator core is mounted, and
at least one of a surface of the lower thrust member disposed to face a surface of the rotating part and the surface of the rotating part includes a lower thrust dynamic pressure generating groove formed therein.

2. The spindle motor of claim 1, wherein the lower thrust member includes:
a disk part having a disk shape;
a sealing part bent from the disk part in an axial direction and forming, together with the rotating part, a first liquid-vapor interface; and
a mounting part extended from the sealing part and having the stator core mounted on an outer surface thereof.

3. The spindle motor of claim 2, wherein the mounting part includes:
an extension wall body having an outer surface bonded to an inner peripheral surface of the stator core; and
a installation guiding wall bent from the extension wall body and bonded to an upper surface of the stator core.

4. The spindle motor of claim. 3, wherein the base member includes a coupling part for increasing an area of contact thereof with the lower thrust member, and
a spacing distance between a lower surface of an inner diameter portion of the stator core and an upper surface of the coupling part is greater than a spacing distance between an upper surface of the inner diameter portion of the stator core and a lower surface of the installation guiding wall when the stator core is mounted on the mounting part.

5. The spindle motor of claim 2, wherein the mounting part includes:
a first wall body extended from the sealing part in a radial direction;
a second wall body extended from the first wall body downwardly and upwardly in the axial direction; and
a installation guiding wall extended from an upper end portion of the second wall body in the radial direction.

6. The spindle motor of claim 5, wherein the lower thrust member is configured of two members separated in a region in which the first wall body is disposed or formed integrally with each other.

7. The spindle motor of claim. 5, wherein the base member includes a coupling part for increasing an area of contact thereof with the lower thrust member, and
a lower surface of the first wall body is provided with a recessed groove into which the coupling part is inserted.

8. The spindle motor of claim 2, wherein the mounting part includes:
a support wall body supported by an upper surface of the base member and having a seating surface on which the stator core is seated; and
a bonding wall body to which an inner peripheral surface of the stator core is bonded.

9. The spindle motor of claim 8, wherein a surface of the base member disposed to face a lower surface of the support wall body is flat.

10. The spindle motor of claim 2, wherein the mounting part includes:
a horizontally extended wall body extended from an upper end portion of the sealing part in a radial direction;
a seating wall body extended from a lower end portion of the horizontally extended wall body; and
a vertically extended wall body extended from an upper end portion of the horizontally extended wall body upwardly in the axial direction and having an inner peripheral surface of the stator core bonded thereto.

11. The spindle motor of claim 10, wherein the base member includes a coupling part inserted into a mounting groove formed in a lower surface of the horizontally extended wall body.

12. The spindle motor of claim 1, wherein the upper flange member includes:
a body having a disk shape; and
a protrusion part extended from the body downwardly in an axial direction and inserted into an insertion groove of the rotating part, and
the thrust member is inclined in order to form, together with an outer sidewall forming the insertion groove, a second liquid-vapor interface.

13. The spindle motor of claim 12, further comprising a cover member installed on any one of an upper end portion of the upper flange member and the rotating part to prevent leakage of the lubricating fluid.

14. The spindle motor of claim 1, wherein the rotating part includes:
a sleeve forming, together with the upper flange member, the lower thrust member, and the shaft, the bearing clearances; and
a rotor hub extended from the sleeve.

15. The spindle motor of claim 1, wherein the mounting part and a surface of the rotating part disposed to face the mounting part form a labyrinth seal.
